(19) United States
(12) Patent Application Publication
(10) Pub. No.: US 2009/0242144 A1
(43) Pub. Date: Oct. 1, 2009

(54) Window covering

(76) Inventors: Fu-Lai Yu, San Hsia Town (TW); Chin-Tien Huang, San Hsia Town (TW)

Correspondence Address: Olson & Cepuritis, LTD., 20 NORTH WACKER DRIVE, 36TH FLOOR, CHICAGO, IL, 60606, US

(21) Appl. No.: 12/383,214

(22) Filed: Mar. 20, 2009

Related U.S. Application Data
(63) Continuation-in-part of application No. 11/904,748, filed on Sep. 28, 2007.
Application No. 11/904,748 is a continuation of application No. 10/914,579, filed on Aug. 9, 2004, now Pat. No. 7,275,580.
Application No. 10/914,579 is a continuation-in-part of application No. 10/427,829, filed on May 1, 2003, now Pat. No. 6,932,138.
Application No. 10/427,829 is a continuation of application No. 11/070,126, filed on Mar. 1, 2005.
Application No. 11/070,126 is a continuation-in-part of application No. 10/930,021, filed on Aug. 30, 2004, now abandoned.
Application No. 10/930,021 is a continuation of application No. 10/413,200, filed on Apr. 14, 2003, now Pat. No. 6,792,996.
Application No. 11/070,126 is a continuation-in-part of application No. 10/427,829, filed on May 1, 2003, now Pat. No. 6,932,138.

(51) Int. Cl. E06B 9/30

(52) U.S. Cl. 160/176.1 R

(57) ABSTRACT

A window covering having a head rail and a plurality of rows suspended from the head rail by a securement cord member and at least one opening cord member is provided. Each of the plurality of rows is collapsible and includes a pair of opposed longitudinal regions. The distance between the opposed longitudinal regions is varied by moving the securement cord member, the opening cord member, or both. The rows are also tilted into an open or closed position by moving the securement cord member, the opening cord member, or both. A bottom rail may also be provided and suspended from the head rail such that the plurality of rows are located between the head rail and the bottom rail.

This is a continuation in part of application U.S. Ser. No. 11/904,748, filed on Sep. 28, 2007, which is a continuation of application Ser. No. 10/914,579 filed on Aug. 9, 2004, which is a continuation in part of application Ser. No. 10/427,829, which was filed on May 1, 2003, and issued as U.S. Pat. No. 6,932,138 on Aug. 23, 2005. This is also a continuation of application U.S. Ser. No. 11/070,126, filed on Mar. 1, 2005, which is a continuation-in-part of application U.S. Ser. No. 10/930,021, filed on Aug. 30, 2004, which is a continuation of U.S. Ser. No. 10/413,200, filed on Apr. 14, 2003, now issued as U.S. Pat. No. 6,792,996, and a continuation-in-part of U.S. Ser. No. 10/427,829, filed on May 1, 2003, and issued as U.S. Pat. No. 6,932,138 on Aug. 23, 2005. Each of the aforementioned patents and applications are hereby incorporated by reference.

### TECHNICAL FIELD OF THE INVENTION

This invention relates to an improved window covering. More particularly, this invention relates to an improved window covering having the general appearance of a Roman shade but having the ability to provide openings at intervals.

### BACKGROUND OF THE INVENTION

One popular type of window covering is known as a Roman shade. This type of shade consists of a fabric material attached along its top edge to a head rail and gathered at spaced intervals to provide a series of soft folds across the face of the fabric. Consequently, the typical Roman shade has a cascaded or softly pleated appearance. Such Roman shades are constructed so that when they are raised, they gather from the bottom in generally horizontal folds or pleats until the entire shade resides near the top of the window covering. In some versions, the top of the window covering may also be lowered. The shades are operated by pulling on various lines which are used in conjunction with guides attached to the shade.

Most prior art Roman shades are formed either of a flexible material such as a fabric or of a plurality of panels, and are provided with a plurality of horizontal folds at points vertically spaced from one another to form the pleats when the shade is raised. A common method for making a Roman shade is to sew at least two sets of rings or connectors along vertical lines down the back of the fabric material such as is shown in U.S. Pat. No. 1,321,800. A lift cord passes from the head rail through each set of rings and may either be fastened to the bottom edge of the fabric or loop around the bottom edge of the fabric up the front face of the fabric and return to the head rail. Alternatively, each set of connectors is both sewn to the fabric and attached to a cord at spaced apart intervals along the cord. The interval between spacers on each cord may be equal to or less than the distance between the points at which the spacers are attached to the back of the fabric.

One drawback to the typical Roman shade, however, is that there is no way to create openings in the overall face of the window covering if one wishes to permit light into a room, such as found in Venetian blinds by tilting the blind slats, without having to raise the bottom, or lower the top of the entire window covering, which undesirably results in a substantial loss of privacy. Therefore, it is desired to provide the ability to, similar to a Venetian blind, open gaps in the shade to allow light to pass, yet maintain a relatively high degree of privacy by not requiring the shade to be raised or lowered.

### SUMMARY OF THE INVENTION

The present invention relates to a decorative covering suitable for use as a window shade. The decorative covering comprises a head rail with at least one securement cord member and at least a first opening cord member. The decorative covering also includes rows that are suspended from the head rail by the securement cord, and which are typically hung over a window as a shade.

The window covering preferably includes a plurality of securement cord members and a plurality of opening cord members suspended from the head rail. Each of the plurality of securement cord members is restrainedly positioned with each of the plurality of rows at a first transverse margin or longitudinal region of the individual rows. Each of the rows also defines a plurality of row portions spaced in a transverse direction. Each of the rows is also connected to at least one opening cord member at a transverse margin or longitudinal region opposite that of the transverse margin or longitudinal region to which the securement cord members are restrainedly positioned, and to at least one of the row portions. A vertical adjustment mechanism is operatively connected to each of the opening cord members and each of the securement cord members, which enables the opening cord members and securement cord members to be moved to open or close the spaced row portion of the rows restrainedly positioned therewith. A single adjustment mechanism can be operatively connected to all the opening cord members and securement cord members, or each of a plurality of opening cord members and securement cord members can be operatively connected only to certain opening members.

The rows or row portions of the window covering can be opened and closed through individual movement of the opening cord members, the securement cord members or a combination of both. The rows are opened and closed by adjusting the distance between the transverse margins or longitudinal portions of the rows and by tilting the physical position of the rows between a vertical plane and a horizontal plane.

For example, the transverse margins or longitudinal portions of the rows are brought closer together to collapse the rows and to tilt the plane of the row toward a horizontal position. The transverse margins or longitudinal portions of the rows are moved apart to expand the rows and to tilt the plane of the row toward a vertical position.

If the opening cord member is secured to the lower edge of the rows, when the opening cord member is retracted, the lower edge of each row is raised relative to the upper edge and drawn up behind the front of the row such that openings created in the face of the window covering permit light and air to pass. At the same time, the retraction of the opening cord member tilts the plane of the row toward a horizontal position, allowing additional light and air to pass. Extending the opening cord member through use of the vertical adjustment mechanism causes the lower edge of each row with which it is connected to lower relative to the upper edge and thereby close the gaps of the window covering. At the same time, the extension of the opening cord member tilts the plane of the row toward a vertical position.

Likewise, if the securement cord member is secured to the upper edge of the rows, when the securement cord member is extended, the upper edge of each row is lowered relative to the lower edge creating space between rows and permitting light and air to pass. At the same time, the extension of the securement cord tilts the plane of the row toward a horizontal position, allowing additional light and air to pass. Retracting the securement cord member through use of the vertical adjustment mechanism causes the upper edge of each row with which it is connected to raise relative to the lower edge and thereby close the gaps of the window covering. At the same time, the retraction of the securement cord member tilts the plane of the row toward a vertical position.

It should be understood that both the securement cord member and the opening cord member can be adjusted as desired. In other words, either the securement cord member can be adjusted, or the opening cord member can be adjusted, or both of the securement and opening cord members can be adjusted to create openings in the decorative covering. It should further be understood that, in one embodiment, the opening cord member and the securement cord member are capable of individual movement.

The tilting of the rows occurs based upon a number of cooperating forces that are applied to each of the rows. A gravitational closing force is applied about the center of gravity of each of the rows. This gravitational closing force urges the front or distal end portion of the rows to move downwards towards a closed position. A countervailing lifting force is applied to each of the rows by the opening cord member which tends to cause the rows to tilt upwards and to open. A further counterbalancing force is applied to each of the rows by the securement cord member.

The gravitational closing force is a constant downward force, which is offset by and at equilibrium with the lifting force when the position of the rows is stationary. When the opening cord member is extended by the vertical adjustment mechanism in the head rail, the lifting force is decreased such that the gravitational force overcomes the lifting force and the rows are tilted towards a closed position. By contrast, when the opening cord member is retracted by the vertical adjustment mechanism in the head rail, the lifting force is greater than the gravitational closing force so the rows are tilted upwards or opened.

The counterbalancing force is, however, greater than either of the gravitational force or the lifting force so rows pivot about a longitudinal region proximal to the front or distal end portion. This pivot region remains substantially vertically stationary relative to the head rail when the vertical adjustment mechanism raises and lowers the opening cord member and the securement cord member. Providing a sufficient counterbalancing force can be accomplished in several manners. For example, the bottom rail can be of a sufficiently heavy weight to overcome the lifting force that may be applied to the rows.

The securement cord member can also be raised and lowered by the vertical adjustment mechanism. When the securement cord member is retracted by the vertical adjustment mechanism in the head rail, the lifting force on the proximal side of the pivot region is increased and the gravitational force on the distal side of the pivot region complements this force such that the rows are tilted towards a closed position. By contrast, when the securement cord member is extended by the vertical adjustment mechanism in the head rail, the lifting force on the proximal side of the pivot region is decreased and overcomes the gravitational force on the distal side of the pivot region so the rows are tilted upwards or opened. In particular, the vertical adjustment mechanism raises and lowers the securement cord and opening cord members in opposite vertical directions relative to one another, to pivot each row about a longitudinal region proximal to the front or distal end portion.

Restrained positioning of the rows with the securement cord member can be accomplished in several manners including, but not limited to, fixedly securing with adhesive, ultrasonic welding, knitting, tying or the like, or restricting the movement of the row relative to the securement cord member with a stop or other like restricting member. For example, the movement of the rows can be restricted by stop mechanisms positioned on the securement cord member. The opening cord member, which also connects the head rail and the rows, may be similarly restrainedly positioned.

The transverse margin or longitudinal regions to which the securement cord members are restrainedly positioned preferably are about either the upper and lower edges of the row, which extend across the width of the window shade. The opening cord member is restrainedly positioned about the opposite transverse margin or longitudinal regions. If desired, a rigid securement strip can be used to aid in restrainedly positioning the opening and securement members with the rows. Reinforcing strips can also be included along either or both of the opposed longitudinal regions.

Each of the plurality of rows may be comprised of fabric material, such as a single continuous fabric material or a plurality of fabric materials. The panels may also be formed from other materials such as wooden strips or slats. As discussed, each of the rows includes a plurality of spaced row portions, such as a first and a second side region. The first and second side regions may be of equal size, thereby forming a rectangular shape, or may be of different sizes, so as to form a tapered or substantially triangular shape. The rows may also include a stiffened transverse portion, such as by inclusion of a strip member with the first transverse margin, such as a lightweight plastic slat.

The vertical adjustment mechanisms that are operatively connected to the various opening members and the securement members, may be similar to mechanisms commonly found in Venetian blind systems for adjusting the position of cords, such as a worm gear assembly fitted within the head rail and manipulable by an operatively connected wand, whereby turning the wand causes the opening cord member or the securement cord member to be retracted or extended. Alternatively, a cord lock assembly can also be utilized with the opening cord member and the securement cord member. As yet another alternative, a power driven or remotely controlled vertical adjustment mechanism can also be utilized to retract or extend the opening cord member and securement cord member.

### BRIEF DESCRIPTION OF THE DRAWINGS

In the drawings,

FIG. 1 is a perspective front view of a preferred embodiment of a window covering in a closed position according to the present invention;

FIG. 2 is a perspective front view of the window covering of FIG. 1 in a partially open position;

FIG. 3 is a perspective rear view of a preferred embodiment of a row from the window covering of FIG. 1;

FIG. 4 is a cross sectional view of the row of FIG. 3;

FIG. 5 is an enlarged perspective view of a preferred embodiment of a row with an alternate method of securing the row to the securement member;

FIG. 6 is an enlarged cross sectional view of the embodiment of FIG. 5;

FIG. 7 is a perspective rear view of another alternate embodiment of a row from a window covering according to the present invention;

FIG. 8 is a cross section view of the row of FIG. 7;

FIG. 9 is a perspective rear view of another alternate embodiment of a row comprising slats from a window covering according to the present invention;

FIG. 10 is a perspective view of the embodiment of FIG. 9, with the slats partially retracted;

FIG. 11 is a perspective rear view of yet another alternate embodiment of a row from a window covering according to the present invention;

FIG. 12 is a cross section view of the row of FIG. 11; and

FIG. 13 is a perspective view of another embodiment of a decorative covering of the present invention;

FIG. 14 is a side elevated view of the decorative covering of FIG. 13;

FIG. 15 is a cross sectional view of a row of FIG. 13;

FIG. 16 is a perspective rear view of another alternate embodiment of a row from a window covering according to the present invention;

FIG. 16A is an enlarged partial view of FIG. 16;

FIG. 17 is a perspective rear view of the row of FIG. 16 with the opening member partially retracted;

FIG. 17A is an enlarged partial view of FIG. 17;

FIG. 18 is a perspective rear view of the row of FIG. 16 fully retracted;

FIG. 18A is a enlarged partial view of FIG. 18;

FIG. 19 is a cross sectional side view of a pair of adjacent rows partially opened;

FIG. 20 is a cross sectional side view of adjacent rows of an alternative embodiment of a window covering in the opened position;

FIG. 21 is a foreshortened side view of the window covering of FIG. 20 in the closed position;

FIG. 22 is a cross sectional side view of adjacent folded panels of another alternative embodiment of a window covering in the opened position; and

FIG. 23 is a foreshortened side view of the window covering of FIG. 22 in the closed position.

### DESCRIPTION OF THE PREFERRED EMBODIMENTS OF THE INVENTION

The invention disclosed herein is susceptible of embodiment in many different forms. Shown in the drawings and described hereinbelow in detail are preferred embodiments of the invention. It is to be understood, however, that the present disclosure is an exemplification of the principles of the invention and does not limit the invention to the illustrated embodiments.

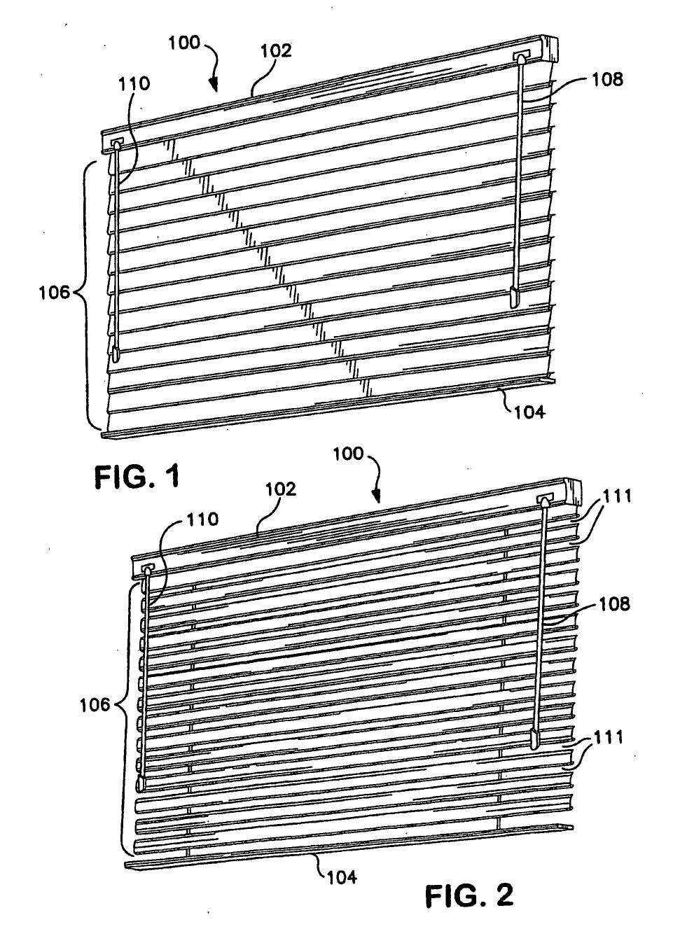

A preferred embodiment of the present invention is shown in FIGS. 1 and 2. Window shade 100 is shown in a closed position, and includes a head rail 102, a bottom rail 104, and a plurality of rows 106. Also preferably provided is an opening wand 108 for narrowing the profile of individual rows and tilting the rows toward a horizontal plane thereby creating gaps or openings in the overall face of window shade 100, as well as a raising wand 110 for raising the entire shade 100. Other opening or raising members such as cords can be used instead of the wands 108, 110.

If it is desired to allow light into a room without raising the entire shade, and thereby retaining a degree of privacy, a user can rotate the opening wand 108. As the opening wand 108 is rotated, each of the plurality of rows 106 is adjusted to narrow its profile by drawing a portion of the panel behind the face of the particular row and by tilting toward a horizontal place such that gaps 111 in the window shade 100 are opened as shown in FIG. 2. Although it is not shown in FIGS. 1 and 2, the vertical adjustment mechanism can be a cord lock as is readily available in the art which enables a person to adjust the position of the cords as desired. The particular procedure for opening each of the plurality of rows is discussed in further detail below.

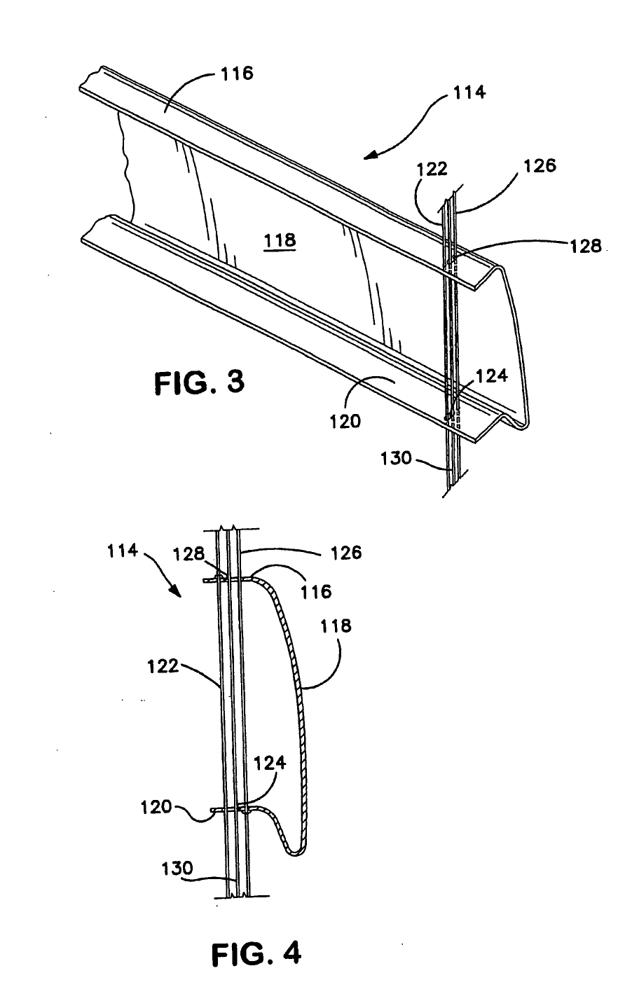

Referring to FIGS. 3 and 4, the narrowing of the longitudinal profile of one of the plurality of rows from the window covering of FIGS. 1 and 2 is explained. In this embodiment, a row 114 is formed of a single panel of fabric having an upper longitudinally extending region 116, a central longitudinally extending region 118, and a lower longitudinally extending region 120. The aggregate of the central region 118 for each of the rows forms the overall face of the window covering. As discussed above, each row may be comprised of multiple pieces of fabric. For example, the upper and lower longitudinally extending regions 116 and 120 could be formed of one type of fabric, whereas the central longitudinally extending region 118 could be a fabric of a different color, opacity, texture or the like.

Passed through the upper region 116 and the lower region 120 is a securement member, such as cord 122, which is secured to the upper region 116 by way of adhesive, ultrasonic welding, knitting, or the like. Cord 122 is passed through a hole 124 defined by the lower region 120, such that cord 122 is not secured to the lower region 120. Alternatively, cord 122 does not pass through lower region 120, but passes only through upper region 116.

An opening member, such as cord 126 is also provided. Cord 126 is passed through hole 128 defined by the upper region 116, and is secured to lower region 120, also by way of adhesive, ultrasonic welding, knitting, or the like. Each of the plurality of rows is similarly secured to the cords 122 and 126. Alternatively, cords 122 and 126 may be passed through holes, but would include stops fixedly secured thereto so as to limit the cords from passing through the holes. For example, annular members such as washer shaped pieces that are positioned and fixed by pinching the annular member on the opening member and securement member can be utilized.

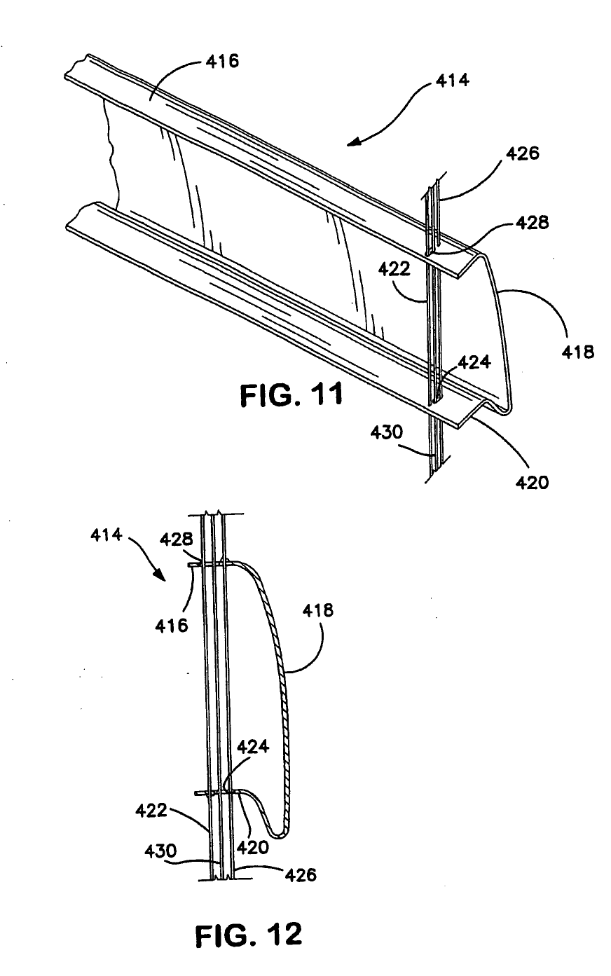

In this embodiment, as opening member, such as cord 126, is retracted by way of a vertical adjustment mechanism (not shown) in the head rail 102 (FIG. 1), which is operatively connected to the opening wand 108 (FIG. 1), the lower region 120 is urged towards the upper region 116. The securement member, such as cord 122, is extended and the upper region 116 is urged toward the lower region 120, as shown further at FIG. 11. The movement of the opening member and securement member in opposite direction causes the collapsible row 114 to fold upon itself to present a narrower longitudinal profile. At the same time, the plane of the row 114 is tilted toward horizontal. As shown in FIG. 2, openings 111 are created in the plurality of rows to permit light through without requiring the raising or lowering of the entire window covering 100.

Referring again to FIGS. 3 and 4, a raising member, such as cord 130 for raising the bottom rail 104 and the plurality of rows 106 is also passed through holes 124 and 128 and secured to bottom rail 104. The raising member, such as cord 130, is operatively connected to raising wand 110 (FIG. 1). Although only one set of cords 122, 126, and 130 is shown, it is preferred that two of sets of cords be provided which are equidistantly spaced from opposite edges of the window covering as can be seen in FIG. 2.

A reinforcing strip may also be included along either the upper longitudinally extending region, the lower longitudinally extending region, or both. This reinforcing strip may be comprised of a thin metal strip, plastic, reinforced material or the like secured to the upper or lower longitudinally extending regions, respectively. Such a reinforcing strip may be included with any of the embodiments disclosed herein.

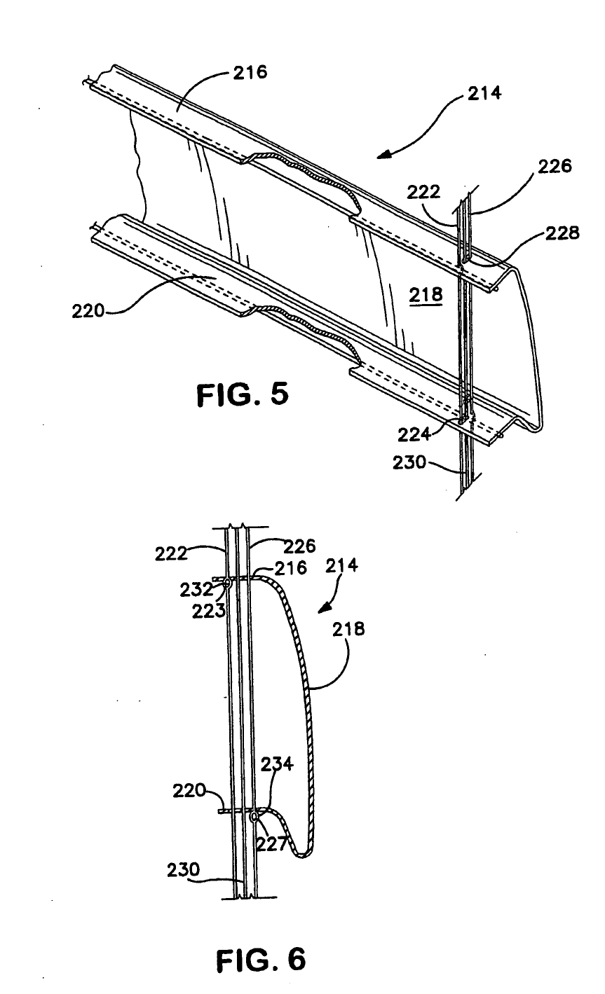

As discussed above, the securement member and opening member can be restrainedly positioned with the plurality of rows in a variety of ways. Shown in FIGS. 5 and 6 one embodiment utilizes plastic strips. Similar to the embodiment described in FIGS. 3 and 4, a row 214 is formed of a single piece of material having an upper longitudinally extending region 216, a central longitudinally extending region 218, and a lower longitudinally extending region 220. Passed through hole 228 in the upper region 216 and hole 224 in the lower region 220 is a securement member, such as cord 222. Alternatively, cord 222 does not pass through lower region 220. Similarly, opening member 226 is passed through hole 228 in the upper region 216 and hole 224 in the lower region 220. Formed with securement member 222 and opening member 226 are loops 223 and 227, respectively. Securement strips 232 and 234 that are preferably formed of plastic are passed through loops 223 and 227, respectively, and are positioned relative to the row 214 as depicted such that the downward movement of the row relative to the securement member 222 and opening member 226 are restricted. If desired, strips 232 and 234 can be fixedly secured to the row 214, such as by an adhesive.

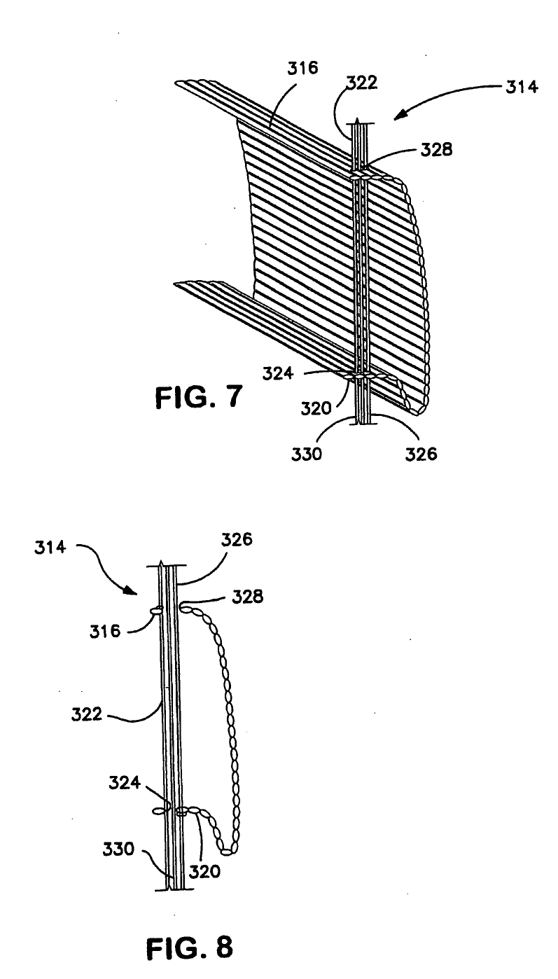

An alternative of the present invention is shown in FIGS. 7 and 8. In this embodiment, the plurality of rows is comprised of a plurality of rigid slats. Such slats can be relatively wide slats as typically found in wooden Venetian blinds, or as shown, can be relatively narrow strips of decorative wood, such as wicker, rattan or bamboo. A plurality of relatively narrow strips of wood make up the plurality of rows such as row 314. An upper region 316 is provided with the plurality of wood strips, and defines a hole 328. The upper region can be comprised of a single strip or may be a number of strips. A lower region 320 can similarly be formed and also defines hole 324. Passed through the upper region 316 and the lower region 320 is a securement member 322, which is secured to the upper region 316 as described above, and is passed through hole 324 in the lower region 320 and is not secured to the lower region 320. Alternatively, cord 326 does not pass through lower region 320. An opening member 326 is passed through hole 328 and secured to lower region 320. A raising member 330 for raising the bottom rail and the plurality of rows as described above with the other embodiments is also passed through holes 324 and 328. Similar to the previous embodiments, a cord 326 is retracted such that lower region 320 is pulled towards upper region 316 to create gaps in the overall face of the window shade.

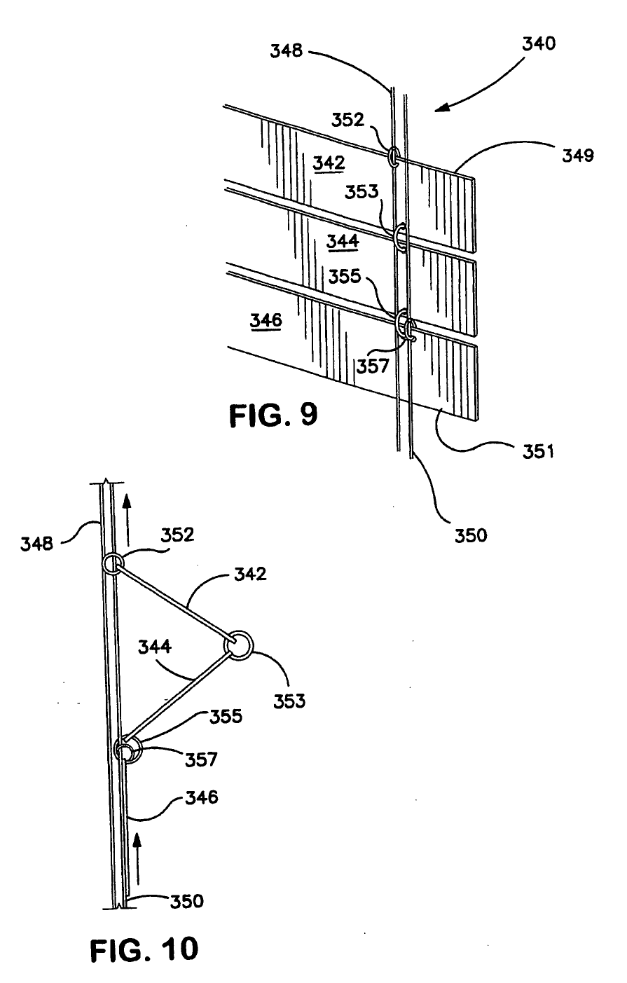

Shown in FIGS. 9 and 10 is an embodiment of the present invention wherein each of the plurality of rows is comprised of slats, such as those typically found in wooden Venetian blinds. In this example, the row 340 is comprised of three slats, 342, 344, and 346, but more slats can be used. Row 340 has an upper edge 349 and a lower edge 351. Securement member 348 is secured to slat 342 about an upper edge 349 by ring 352. Opening member 350 is secured to slat 346. In this particular embodiment, rings 353 and 355 connect slats 342, 344, and 346. An additional ring 357 is secured to lowermost slat 346, to which opening member 350 is secured. Row 340 shown in FIG. 9 is in a general “closed” position. In this position, the slats of row 340 extends along a generally vertical plane, and upper edge 349 and lower edge 351 are separated by a distance. In this “closed” position, there will be little if any gap between row 340 and adjacent rows above or below row 340.

Referring to FIG. 10, the adjustment of row 340 into an “open” position is shown. As the opening member 350 is retracted, lowermost slat 346 is pulled upwards, which causes slats 342 and 344 to deflect and fold onto one another. Securement member 348 can also be extended to allow uppermost slat 342 to move downwards.

The upward movement of opening cord 350 or the downward movement of securement cord 348, or both, collapses row 340 by decreasing the distance between upper edge 349 and lower edge 351. This movement of opening cord 350 and securement cord 348 also pivots the slats of row 340. For example, slat 342 moves from a generally vertical plane (shown in FIG. 9) to a generally horizontal plane as shown in FIG. 10. In this manner, row 340 is opened by collapsing and pivoting row 340. This opening action creates a gap between row 340 and adjacent rows (not shown) above or below row 340.

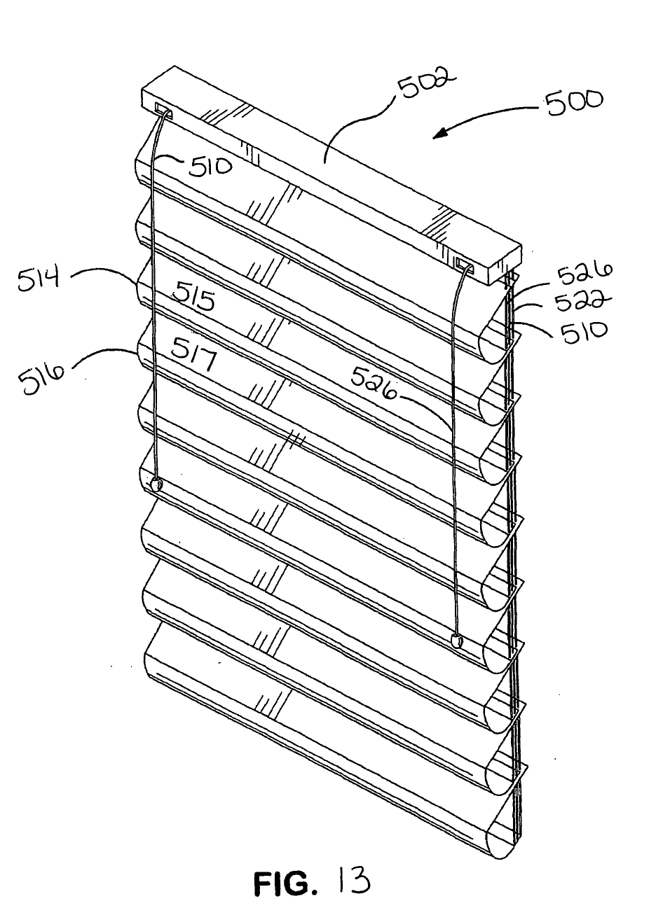

In each of the embodiments shown thus far, gaps in the face of the window shade, i.e., the open position, have been created by pulling the lower region with the opening cord member and by dropping the upper region with a securement cord member. These actions move the lower region and upper region toward each each other. The positions of the securement cord member and the opening cord member can be switched as shown in detail in the embodiment shown in FIGS. 11 and 12.

In this embodiment, a row 414 is formed of a single piece of fabric having an upper longitudinally extending region 416, a central longitudinally extending region 418, and a lower longitudinally extending region 420. Passed through the upper region 416 and the lower region 420 is a securement member 422, which is fixedly secured to the lower region 420. Securement member 422 is passed through a hole 428 defined by the upper region 416, such that it is not secured to the upper region 416. An opening member is also provided, and is secured to upper region 416. In this embodiment, as opening member 426 is extended by way of a vertical adjustment mechanism in the head rail, the upper region 416 is lowered towards the lower region 420. As such, the collapsible row 414 folds upon itself to present a narrower longitudinal profile. At the same time, the plane of the row is tilted toward horizontal.

Similar to the previous embodiments, a raising member, such as cord 430 for raising the bottom rail and the plurality of rows is also passed through holes 424 and 428. A similar arrangement whereby the upper region is lowered to the lower region can be utilized in any of the configurations previously described. As discussed above, it is contemplated that the opening member and securement members may be interchangeable and each provide the ability to raise or lower the longitudinal portion respectively secured thereto. The opening member and securement member can be used in conjunction with each other to simultaneously lower the upper region and to raise the lower region to fold the row upon itself to present a narrower longitudinal profile. Moving the opening member and the securement member together is particularly useful to tilt the rows as well.

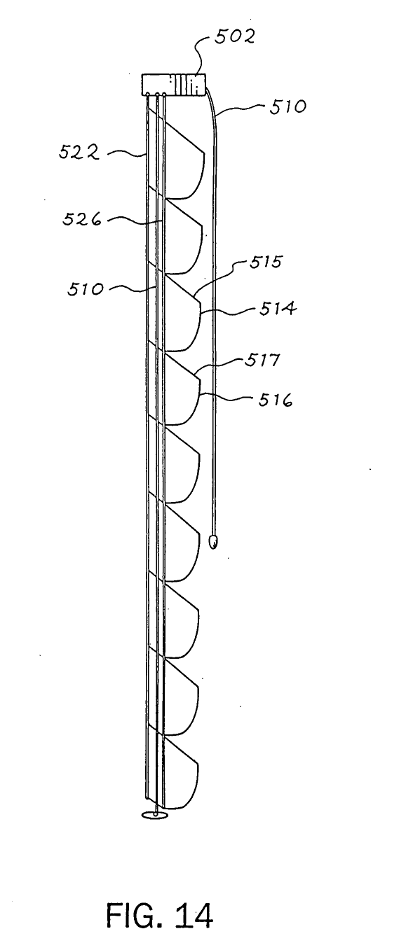

Shown in FIGS. 13-15 is an additional alternative embodiment of the window covering of the present invention. The basic structure of this embodiment is similar to that discussed above with respect to FIG. 3. As shown in FIGS. 13 and 14, window shade 500, which is shown in a closed position, includes a head rail 502 and a plurality of rows comprising panels, such as rows 514 and 516. Also preferably provided is an opening cord 526 and securement cord 522 for narrowing the profile of the rows and tilting the rows thereby creating gaps or openings in the overall face of window shade 500. Also shown is a raising cord 510 for raising the entire shade 500.

Window covering 500, however, includes an additional feature. Each of the rows of window covering 500, such as rows 514 and 516, have stiffened top portions 515 and 517, respectively. There are various ways for providing the stiffened top portion of a row. These include using a non-woven fabric or slat, using a fabric adhered to the top portion, treating the top portion of the row with a stiffening, agent, or the like. Use of a stiffened upper portion provides a unique aesthetic appearance to the decorative covering.

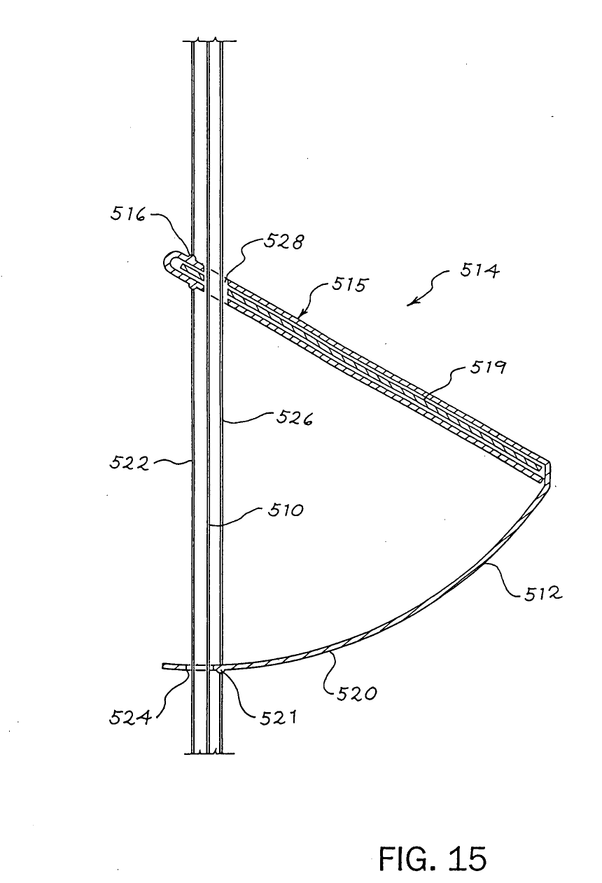

The incorporation of a slat is described in further detail in FIG. 15 with respect to row 514 from FIG. 13. As shown, row 514 comprises a strip of material 512 and a slat member 519. Strip 512 is folded over itself and slat member 519 is sandwiched between the overlapping portions of material 512. Slat member 519 may be fixedly positioned between the overlapping portion of 512 by way of an adhesive.

Passed through the upper region 515 and the lower region 520 of row 514 is a securement cord 522, which is secured to the upper region 515 at upper region edge portion 516 by way of adhesive, ultrasonic welding, knitting, or the like. Securement cord 522 is passed through a hole 524 defined by the lower region 520, such that cord 522 is not secured to the lower region 520. Alternatively, securement cord 522 passes by the lower region 522 without passing through a hole in lower region 522. An opening member, such as cord 526 is also provided. Cord 526 is passed through hole 528 defined by the upper region 515, and is secured to lower region 520 at lower region edge portion 521, also by way of adhesive, ultrasonic welding, knitting, or the like.

Securement cord 522 and opening cord 526 can be independently operable, or can be used in conjunction with each other. The operation of these cords narrows and tilts row 514 shown in FIG. 15.

Specifically, opening cord 526 is retracted by way of a vertical adjustment mechanism (not shown) in the head rail 102 (FIG. 1), which moves the lower region 520 towards the upper region 515. The securement cord 522 is extended and the upper region 515 moves toward the lower region 520. The movement of the opening member and securement member in opposite direction causes the collapsible row 514 to fold upon itself to present a narrower longitudinal profile. This folding moves the upper region 515 adjacent lower region 520. At the same time, the plane of the row 514 is tilted toward horizontal. Stiffened top portion 515 rotates upwards, similar in effect to the tilting of the slats of a Venetian blind. When tilted, the relatively flat and horizontal profile of the rows enables most of the area of the window covering to be opened to let light through.

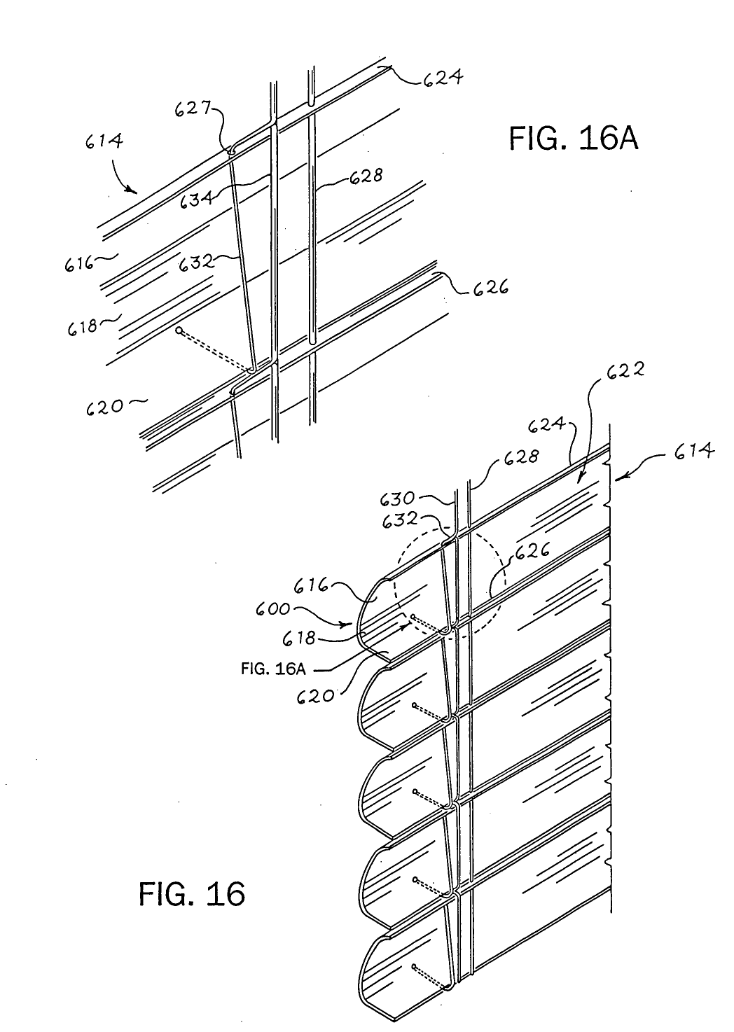

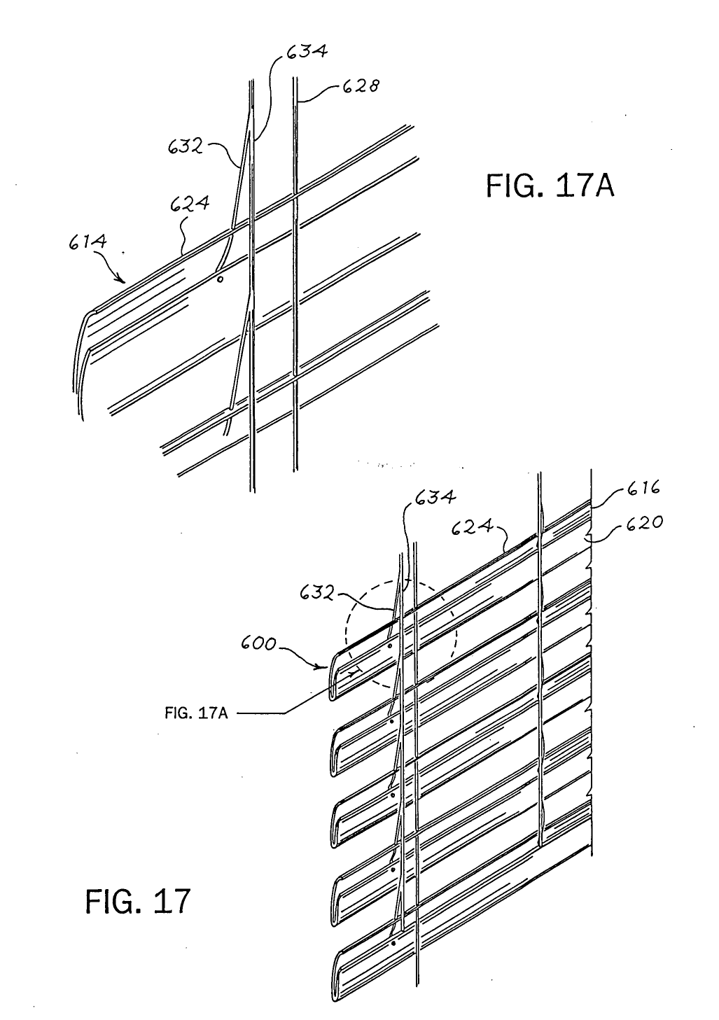

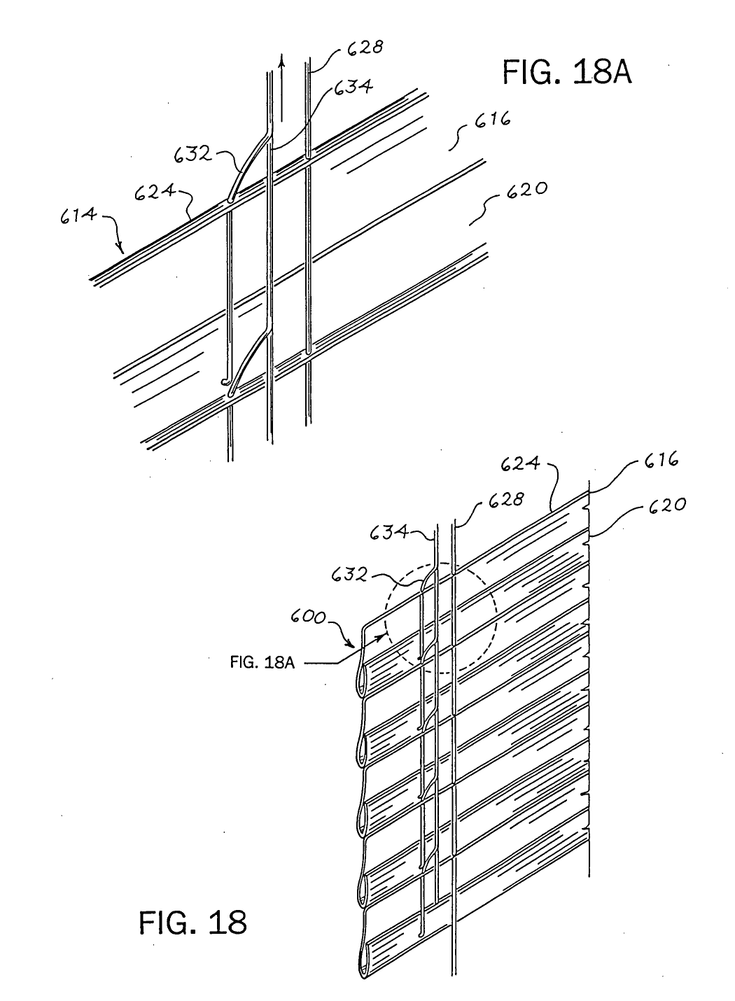

Another embodiment is shown in FIGS. 16 and 16A. In this embodiment, window covering 600 is made of a plurality of rows, such as row 614. Each row is made of a plurality of slats, such as 616, 618, and 620. The row also defines a face (not shown), a rear 622, an uppermost region 624, and a lowermost region 626. As in other embodiments described above, a securement member 628 is restrainedly positioned with the uppermost region 624. An opening member 630 is also provided. In this example, the opening member 630 is comprised of a roll-up member 632 and lifting member 634. The uppermost region 624 defines a hole 627, through which the roll-up member 632 is passed. One end of the roll-up member 632 is connected to the lifting member 634. Preferably, secured to the lifting member 634 are a plurality of roll-up members, one for each row. The roll-up member is passed under the lowermost region 626 of row 614 and is secured to the face of the row 614 about a region adjacent to the lowermost region 626. For example, the roll-up member 632 is secured to the face about a top region of slat 620. As the lifting member 634 is raised, the roll-up member 632 is pulled through the hole 627 such that slat 620 is rolled up as shown in FIGS. 17, 17A, 18 and 18A. As such, the upper region and lower region of row 614 are positioned adjacent to each other and gaps are created in the window covering.

Although shown with a row comprising a plurality of slats, the roll-up member can also be used with a row comprised of a fabric material. In order to lessen the visual effect of the roll-up member, it may be comprised of a material similar in color to the row. As shown, the roll-up member may also serve to limit the extent to which the row is extended such that a billowed appearance is achieved.

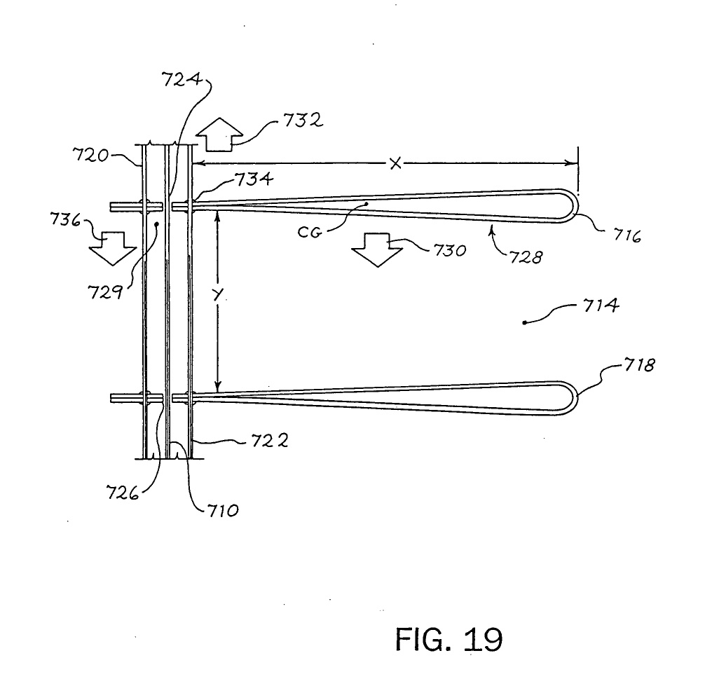

FIG. 19 further illustrates how the vertical adjustment mechanism tilts the rows between an open and closed position by raising and lowering the opening cord member and the securement cord member.

The securement cord member 720 and opening cord member 722 are shown passing through rows 716 and 718. Rows 716 and 718 also define holes 724 and 726 through which is passed raising cord 710. While the cords 710, 720 and 722 are shown to be co-planar, this is not required. The relative positions of the securement cord member 720 and the opening cord member 722 are such that one is positioned distal to the other. As shown, the opening cord member 722 is positioned distal to the securement cord member 720, however, the positions of the opening cord member 722 and securement cord member 720 can be reversed such that the securement cord member 720 is positioned distal to the opening cord member 722.

A row interval is shown as Y and a center of gravity for row 716 is depicted as CG. The width of the front or distal end portion 728 of row 716 is indicated as X extending from the opening cord member 722. While only one set of cords, i.e., securement cord member 720, opening cord member 722, and raising cord 710, is shown in FIG. 18, it is preferred that a pair of sets of cords of similar configuration be equidistantly spaced from opposing sides of the window shade as shown in FIG. 2. The edge portion of row 716 opposite the front edge portion 728 is the rear edge portion 729 to which securement cord member 720 and opening cord member 722 are secured. Opening cord member 722 can also be secured closer to the center of gravity CG to the securement point shown in FIG. 19.

In operation, various forces are applied to the rows. Row 716 of FIG. 19 is discussed by way of example. The gravitational force effectively applied to center of gravity CG is shown as force arrow 730. A lifting force which is depicted as force arrow 732 is also applied to row 716 by opening cord member 722 at the region where row 716 is fixed to opening cord member 722. A counterbalancing force which is shown as force arrow 736 is applied to row 716 by securement cord member 720 at the region where row 716 is fixed to securement cord member 720. When it is desired to adjust the angle of the rows, the vertical adjustment mechanism is preferably controlled by the opening wand 108 (FIG. 1) or other control mechanism. Operating the opening wand 108 extends or retracts the securement cord member 720 and the opening cord member 722 and thereby adjust the angle of the rows. Extending the opening cord member 722 reduces the force 732 such that the gravitational force 730 causes the row 716 to move downwards, whereas retracting the opening cord member 722 increases the force 732 and overcomes the gravitational force 730 and raises the distal end portion 728 and thereby tilts row 716 upwards. As stated, counterbalancing force 736 is greater than lifting force 732 even when opening cord member 722 is being retracted such that the point at which the securement cord member 720 is fixed to the row 716 and the longitudinal region extending therefrom remains vertically stable relative to the head rail during any adjustment of the angle of the rows.

Extending the securement cord member 720 increases the force 736 such that the gravitational force 730 is overcome and row 716 moves upwards into a horizontal position. The upper region and lower region of row 716 are adjacent and both extend along the same general horizontal plane. Retracting the securement cord member 720 decreases the force 736 and the gravitational force 730 lowers the distal end portion 728 and thereby tilts row 716 downwards.

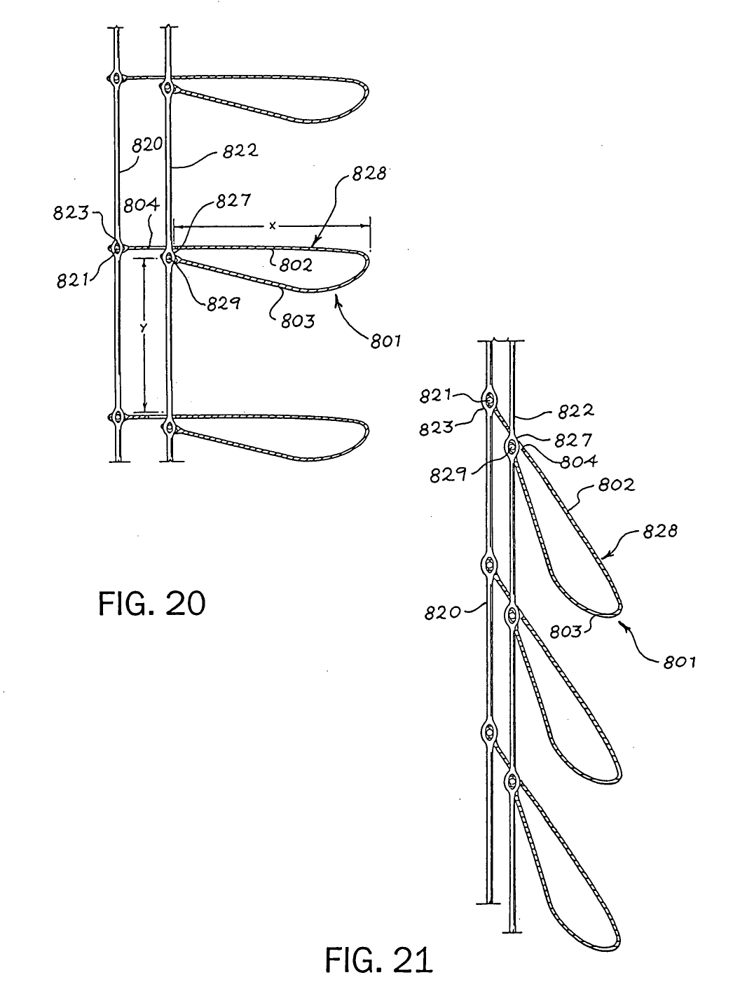

An alternate embodiment of the improved window covering is shown as FIGS. 20-21. The rows 801 can be made from any number of materials, including but not limited to plastic, fabric, laminate, or paper. Each row 801 is folded upon itself, forming a first portion 802, which in this embodiment is the top section of the folded row, and a second portion 803, which in this embodiment is the bottom section of the folded row. The part of the row 801 that extends distally from the opening cord member 822 forms the distal end portion 828, and has a width as indicated by X.

While the row 801 may be folded with a crease, the row 801 is preferably soft folded with a gentle curve as shown to create a more aesthetically pleasing look such as depicted. The use of rows 801 that have been soft folded with a gentle curve is advantageous in that the window covering operationally behaves as a Venetian blind yet retains the pleasing aesthetics of a Roman shade. In this embodiment, the row 801 is folded in an asymmetrical manner such that the first portion 802 is wider than the second portion 803. It should be understood however that the first portion 802 and the second portion 803 may be substantially symmetrical.

The securement cord member 820 and opening cord member 822 are secured to the row 801. In the embodiment shown in FIG. 20, the opening cord member 822 passes through a hole 804 of the folded row 801. Although not shown, a vertical adjustment mechanism may be used to controllably raise or lower the opening cord member 822 or the securement cord member 820, or both, causing the row to narrow or expand, and to tilt.

The relative positions of the first portion 802 and the second portion 803 are maintained by the weight of the row. In other words, the gravitational force from the weight of the row urging the rows 801 to move downward towards a closed position is counterbalanced by a lifting force applied to the row 801 by the securement cord member 820 and the opening cord member 822.

In this embodiment, the securement cord member 820 and opening cord member 822 are formed with loops through which an anchor member 821 detachably secures the row 801 to the securement cord member 820 and opening cord member 822. For example, anchor member 821 is guided through one of the spaced loops defined by securement cord member 820, such as loop 823. The anchor member 821 is also guided through a loop 825 defined by the first portion 802. Similarly, the opening cord member 822 includes a plurality of spaced loops, such as loop 827, through which anchor member 829 is passed. Alternatively, the securement cord member 820 or the opening cord member 822 can be secured to the rows 801 by way of a fastener module to further facilitate removal or interchanging of panels, such as those suggested in U.S. application Ser. No. 10/970,428, for FASTENER MODULE FOR A WINDOW COVERING AND METHOD, filed on Oct. 21, 2004 by Fu-Lai Yu; Chin-Tien Huang; and Shun-Chi Yu, and in U.S. application Ser. No. 11/099,324, for FASTENER MODULE FOR A WINDOW COVERING AND METHOD, filed on Apr. 5, 2005, which are both hereby incorporated by reference.

FIG. 20 shows row 801 in a generally “open” position. In this position first top portion 802 and second bottom portion 803 are adjacent and extend along a generally horizontal plane. The distance between the upper edge of row 801 (proximate anchor member 821) and the lower edge (proximate anchor member 829) is small. This close proximity between the upper edge and lower edge of row 801 narrows the rows profile and creates a gap that allows light and air to pass between adjacent rows above and below row 801. The position of row 801 along a general horizontal axis increases the gap size between adjacent rows.

FIG. 21 shows row 801 in a generally “closed” position. The distance between upper edge (proximate anchor member 821) and lower edge (proximate anchor member 829) of row 801 is greater in the “closed” position of FIG. 21 than in the “open” position of FIG. 20. Row 801 also extends along a generally vertical plane in FIG. 21. In the “closed” position, there will be little if any gap between row 801 and adjacent rows above or below.

The adjustment of row 801 from a “closed” position into an “open” position is accomplished by moving opening cord member 822, securement cord member 820, or both. As opening cord member 822 is retracted, the lower edge of row 801 is pulled upwards. Securement member 348 can also be extended to allow the upper edge of row 801 to move downwards.

The upward movement of opening cord member 822 or the downward movement of securement cord member 820, or both, collapses row 801 by decreasing the distance between the upper and lower edges of row 801 and moving first top portion 802 adjacent second bottom portion 803. This movement of opening cord member 822 and securement cord member 820 also pivots row 801 from a generally vertical plane to a generally horizontal plane. In this manner, row 801 is opened by collapsing and pivoting row 801. This opening action creates a gap for air and light to move between row 801 and adjacent rows (not shown) above or below row 801.

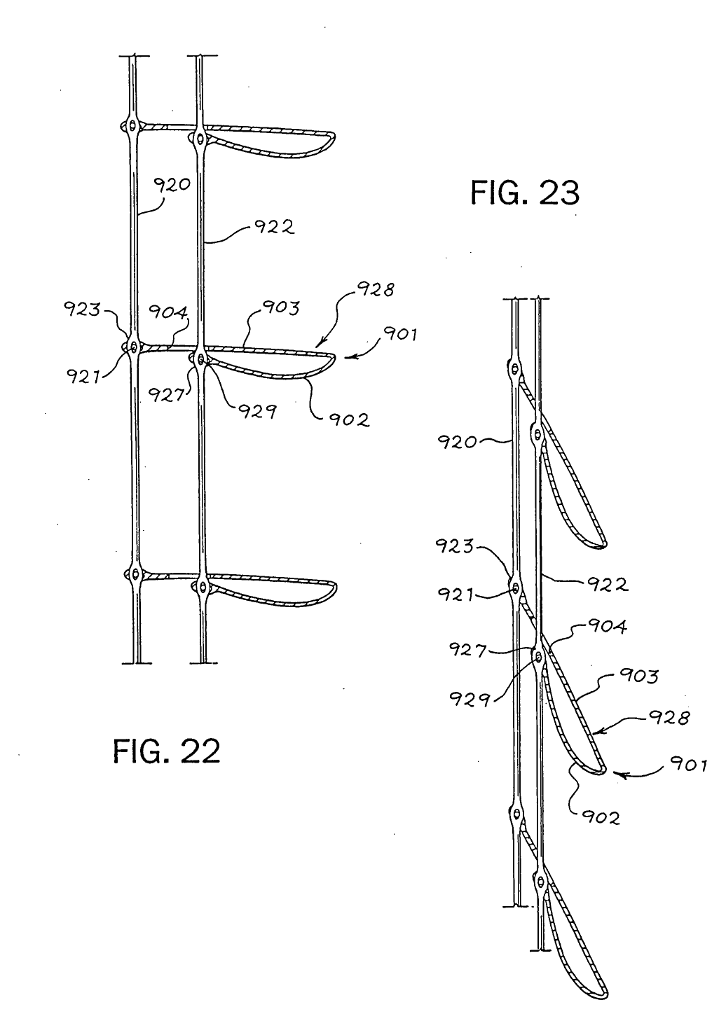

Referring to FIGS. 22 and 23, an alternate embodiment is described. Similar to the previous embodiment, the blind slats are replaced with rows of folded panels, such as panel 901. Each panel 901 is folded upon itself such that first portion 902 is folded over and overlaps with second portion 903. The distal end portion 928 of panel 901 extends distally from the adjustment member 922. The width of the distal end portion 928 preferably is slightly less than the row interval denoted as Y.

The adjustment member 922 passes through a hole 904 defined by the first portion 902 of the folded panel 901. As before, the relative positions of the first portion 902 and the second portion 903 are maintained by the weight of the panel, i.e., the gravitational force from the weight of the panel urging the panels 901 to move downward towards a closed position is counterbalanced by a lifting force applied to the panel 901 by the securement member 920 and adjustment member 922, which passes through hole 904 defined by securement member 920. The securement member 920 and adjustment member 922 are formed with loops. For example, securement member 920 defines a loop 923, and adjustment member 922 defines loop 927. Anchor member 921 and anchor member 929 are guided through loops 923 and 927, respectively. Since the distal end portion 928 is shorter than the row interval Y, when in the closed position, the securement member 920 and adjustment member 922 are partially visible from the face.

Moving row 901 from a “closed” position to an “open” position is achieved in the same manner described above in reference to row 801. Securement member 920 and adjustment member 922 are moved up or down to collapse and pivot row 901.

The foregoing descriptions are to be taken as illustrative, but not limiting. Still other variants within the spirit and scope of the present invention will readily present themselves to those skilled in the art.

What is claimed is:

1. A window covering comprising:
a head rail;
an adjustment mechanism positioned in the head rail;
a first cord member operatively connected to the adjustment mechanism and extending from the head rail;
a second cord member operatively connected to the adjustment mechanism and extending from the head rail;
a third cord member operatively connected to a bottom rail and extending from the head rail,
a plurality of rows;
at least one of the rows comprising a panel having a stiffened upper region with an upper transverse edge portion, and a lower region with a lower transverse edge portion vertically displaced from the upper transverse edge portion;
the upper transverse edge portion being operatively connected to the first cord member, the lower transverse edge portion being operatively connected to the second cord member; and
an adjustment mechanism being adapted to change the position of at least one of the first or second cord members to narrow the vertical displacement between the upper and lower transverse edge portions of at least one of the rows such that the upper region and lower region are adjacent to each other, the adjustment mechanism further adapted to tilt the stiffened upper region and the lower region of the at least one of the rows to create an opening between that row and an adjacent row.

2. The window covering of claim 1, wherein the first cord member and the second cord member are integrally formed.

3. The window covering of claim 1, wherein the panel comprises fabric.

4. The window covering of claim 1, wherein the panel comprises slats of at least one of wood, plastic and metal.

5. The window covering of claim 1, wherein the bottom rail provides a counterbalancing force to a lifting force created by the movement of the first cord member and the second cord member.

6. The window covering of claim 5, wherein the counterbalancing force of the bottom rail overcomes a gravitational force exerted on the plurality of rows causing the at least one row to tilt towards a generally horizontal plane.

7. The window covering of claim 1, wherein the adjustment mechanism is adapted to simultaneously extend the first cord member and to retract the second cord member causing a distal end of the stiffened upper region to move toward the head rail.

8. The window covering of claim 1, wherein the second cord member passes through a hole in the upper transverse edge portion.

9. A window covering comprising:
a head rail;
a first cord member extending from the head rail;
a second cord member extending from the head rail;
a plurality of collapsible rows suspended from the first cord member and the second cord member, at least one of the plurality of rows operatively connected about an upper terminal edge portion to the first cord member and operatively connected about a lower terminal edge portion to the second cord member; and
an adjustment mechanism operable to adjust the vertical position of the first cord member and the second cord member, thereby causing the at least one row operatively connected thereto to collapse and rotate to form an opening between adjacent rows.

10. The window covering of claim 9, further comprising a bottom rail operatively connected to the head rail by a third cord member.

11. The window covering of claim 10, wherein the bottom rail provides a counterbalancing force to the force created by the first and second cord members that allows the at least one row to rotate.

12. The window covering of claim 9, wherein the first cord member and the second cord member are integrally formed.

13. The window covering of claim 9, wherein the adjustment mechanism is adapted to simultaneously extend the first cord member and to retract the second cord member to rotate the at least one row such that a distal intermediate portion of the row moves generally toward the head rail.

14. The window covering of claim 9, wherein at least one row comprises a fabric panel.

15. The window covering of claim 9, wherein the upper terminal edge portion is stiffened.

16. A window shade, comprising:
a plurality of collapsible shade rows;
each row having opposing edge portions and an operating mechanism secured with a plurality of shade rows, wherein the operating mechanism is operable to fully collapse the plurality of rows from a closed state to an opened state by narrowing the rows and by pivoting the rows; and
a bottom rail operatively connected to the plurality of shade rows wherein the bottom rail provides a counterbalancing force to a gravitational force exerted on the shade rows, and wherein this counterbalancing force allows the rows to pivot in a direction opposite the gravitational force.

17. A window covering comprising a plurality of shade rows and an operating mechanism operatively connectable with each of the plurality of shade rows, each of the shade rows comprising:
a first longitudinal region comprising a first distal portion and a first edge portion, the first longitudinal region securable with the operating mechanism at the first edge portion, the first distal region further being stiffened;
a second longitudinal region comprising a second distal portion and a stiffened edge portion, the second longitudinal region securable with the operating mechanism at the stiffened edge portion; and the second distal portion being at least of substantially equal length to the first distal portion;
the operating mechanism comprising a first cord member and a second cord member, and capable of narrowing at least one of the plurality of shade rows by moving the stiffened edge portion and the first longitudinal region toward one another;
the operating mechanism further capable of pivoting at least one of the plurality of shade rows; and
a bottom rail operatively connected to the plurality of shade rows wherein the bottom rail provides a counterbalancing force to a gravitational force exerted on the shade rows, and wherein this counterbalancing force allows the rows to pivot in a direction opposite the gravitational force.
